(19) United States
(12) Patent Application Publication
(10) Pub. No.: US 2024/0167284 A1
(43) Pub. Date: May 23, 2024

(54) CABLE CLIP SYSTEM FOR USE ON FLAT ROOF SURFACE

(71) Applicant: Radiant Solutions Company, Hopkins, MN (US)

(72) Inventor: Steve Kuhl, Minneapolis, MN (US)

(73) Assignee: Radiant Solutions Company, Hopkins, MN (US)

(21) Appl. No.: 18/058,231

(22) Filed: Nov. 22, 2022

Related U.S. Application Data
(60) Provisional application No. 63/264,425, filed on Nov. 22, 2021.

(51) Int. Cl. E04D 13/10; F16L 3/06

(52) U.S. Cl. CPC E04D 13/103; F16L 3/06

(57) ABSTRACT

A roof clip may include a mounting plate including a plurality of infusion holes. A roof clip may include a plurality of cable clamps each including: a first guide, a second guide; and a bendable member joining the first and second guides that is bendable over a heating cable such that, when bent, the heating cable is trapped between the first guide and the second guide.

### PRIORITY CLAIM TO RELATED APPLICATIONS

This application claims priority to related previously-filed U.S. Provisional Patent Application Ser. No. 63/264,425 to Kuhl, filed Nov. 22, 2021, entitled ROOF CABLE CLIPS. The contents of this previously-filed application are incorporated by reference herein in its entirety.

### BACKGROUND OF THE INVENTION

Heated cables are commonly used to prevent ice buildup on roofs in cold climates. The positioning of these cables is critical for the cables to function properly. Roof clips are typically used to connect the cable to the roof top and vary in design according to the type of roof on which they will be deployed.

Flat, horizontal roofs can be especially prone to ice and snow buildup. These roofs appear flat but have slight sloping toward downspouts to prevent puddles of water from forming on the roof. However, during cold winter months, these slopes can get filled with ice, resulting in pooling as water no longer has a path toward the downspouts. Heat cables can be used in and near the downspouts to prevent this from happening. Cable clips that are securable to the flat roof surface are used to prevent the cable routing pattern from changing due to ice and water movement.

In some instances, it would be desirable to have a clip with multiple clamps to maximize the utility of the clip and minimize the number of clips needed for a given pattern.

### OBJECTS AND SUMMARY OF THE INVENTION

The various embodiments of the invention described herein address the aforementioned needs by providing a cable clip system that easily attaches to a flat roof surface and routes a heated cable such that the cable is oriented and maintained in a desired pattern.

In some aspects, the techniques described herein relate to a roof clip for use in securing a heating cable to a flat roof surface including: a mounting plate including a plurality of infusion holes; a plurality of cable clamps each including: a first guide; a second guide; and a bendable member joining the first and second guides that is bendable over a heating cable such that, when bent, the heating cable is trapped between the first guide and the second guide.

In some aspects, the techniques described herein relate to a system for preventing a buildup of ice on a roof, the system including: a plurality of roof clip assemblies fastenable to a flat surface on a roof; a heating cable routable through the plurality of roof clip assemblies; and a routing pattern having a plurality of legs in which each leg is formed by: the heating cable passing through a first cable clamp of one or more of the plurality of roof clips in a sequential order; the heating cable turns back on itself to form a U-shape; the heating cable passes through a second cable clamp of the one or more of the plurality of roof clips in an order that is reverse of the sequential order, thereby forming a leg of the plurality of legs.

In some aspects, the techniques described herein relate to a method of preventing a buildup of ice on a flat roof with a downspout including: fastening a plurality of roof clips to a flat roof surface, each clip having two cable clamps; and routing a heating cable through the plurality of roof clips to form a pattern including a plurality of legs that radiate from a downspout of the roof.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which;

FIG. 1 is a perspective view of an embodiment of a roof clip of the invention;

FIG. 2 is a side elevation of an embodiment of a roof clip of the invention;

FIG. 3 is a plan view of an embodiment of a roof clip of the invention;

FIG. 4 is a perspective view of plurality of roof clips of the invention used to form a desired heat cable pattern on a metal roof with seams; and

FIG. 5 is a perspective view of plurality of roof clips of the invention used to form a desired heat cable pattern on a flat horizontal roof.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

The invention is generally directed to a roof clip10 for use in securing a heating cable to a flat roof surface, in order to prevent a buildup of ice on the roof. The roof clip 10 generally includes a mounting plate 20 and a plurality of cable clamps 100 that extend edges 22 of the plate 20. The mounting plate 20 is fastenable or connectable to a flat roof surface and also includes a plurality of infusion holes 24 passing through the plate to promote infusion of an adhesive used to attach the mounting plate 20 to a flat surface, when the adhesive is compressed between the roof and the mounting plate 20.

Each cable clamp 100 includes connector 102 that joins the cable clamp 100 with the mounting plate 20, and may be an extension of the mounting plate. The cable clamp 100 further includes a first guide 106 and an second guide 108. The first guide 106 and second guide 108 are joined with a bendable member 110. The bendable member 110 is constructed to be bendable by hand, without the use of tools, or using a pliers, yet strong enough to retain the bent configuration while subjected to shifting snow and ice.

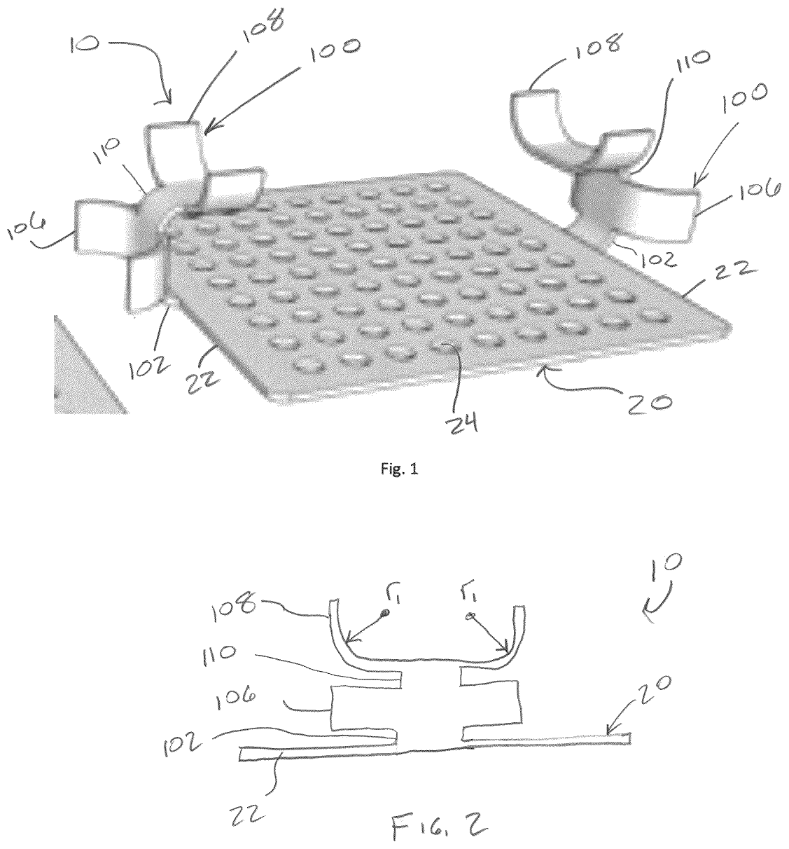

In at least one embodiment, the cable clamps 100 and the mounting plate 20 are constructed from a single sheet of a suitable rigid but bendable material, such as steel or aluminum, and formed into a preinstalled shape, such as that shown in FIG. 1. In these embodiments, the desired bendability of bendable member 110 may be attained by selecting a width that is narrow enough to afford bendability while maintaining sufficient strength.

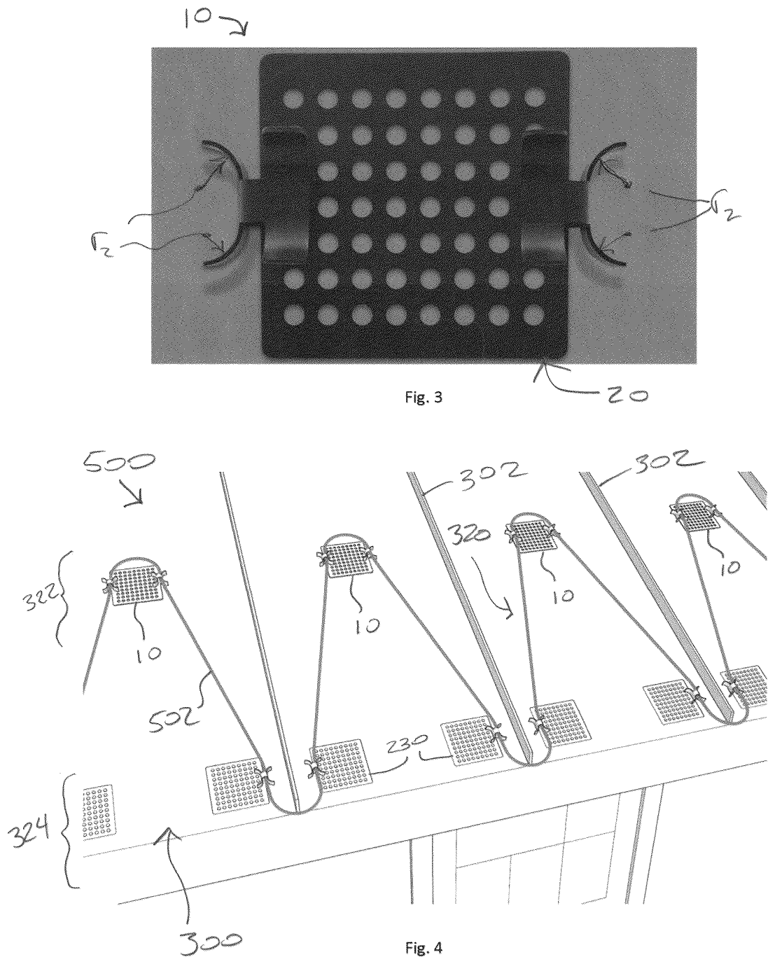

FIGS. 2 and 3 show that the first guide 106 and second guide 108 each have ends curved to predetermined radii r1 and r2, respectively. Radii r1 and r2 may be equal. The curves facilitate entry and exit of the cable into and out of the clamp, thereby gently trapping the cable 502 in the clamp without contacting sharp edges that could damage the cable. Additionally, heated cable routing must meet industry standards, which includes a minimum radius of any bend in the cable. By selecting a predetermined radius r1, r2 that is equal to or greater than the industry standard, the installers are assured of meeting the standards without the need to measure the radius of the cable curves. When the bendable member joining the first guide and the second guide is bent over the heating cable, the heating cable is trapped between the first guide and the second guide.

FIG. 4 is an example of a heated cable system 500 that includes a heated cable 502 and the roof clip 10 and is installed on a roof 300 to form a routing pattern 320. The roof 300 has parallel vertical seams 302 that run directly down the slope of the roof 300. The routing pattern 320 is formed by placing single clamp clip assemblies 230 at a lower location 324 roof clips 10 of the invention at an upper location 322 in a channel formed between each seam 302 of the roof 300. The upper location 322 should be selected such that it is directly above an outside wall of the structure. The lower location 324 should be near a bottom of the roof 300. The routing pattern 320 is then completed by installing a cable 502 through the cable clamps 100 of the roof clips 10 as shown.

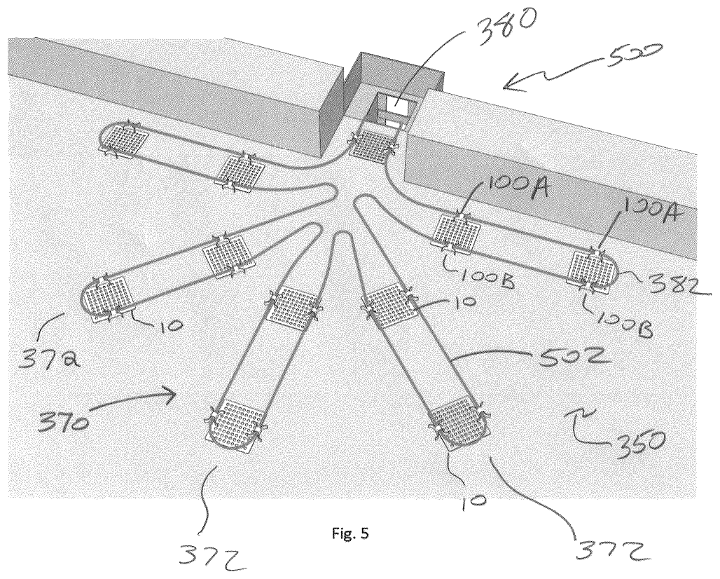

FIG. 5 is an example of a method of preventing a buildup of ice on a flat roof with a downspout using a heated cable system 500 that includes a heated cable 502 and a plurality of roof clips 10. The method involves creating a routing pattern 370 on a horizontal flat roof surface 350. The routing pattern 370 may be a star-shaped pattern formed by adhering a plurality of roof clips 10 to the flat roof surface 350 near a downspout 380. The star-shapped pattern 370 includes a plurality of legs 372 that radiate from the downspout. Each leg includes a plurality of roof clips 10 having first and second cable clamps 100A and 100B, respectively. The heated cable 502 may be routed such that it emerges from the downspout 380, passes through the first cable clamps 100A of the clips 10 in a sequence until the most distant cable clip is reached. The cable is then doubled-back on itself, thereby forming a U-turn 382, and is routed back down the leg through the second cable claims 100B in reverse sequential order. This is repeated for the remaining legs of the pattern 370 and the cable is then routed back into the downspout 380.

The clips 10 each having the two cable clamps 100A and 100B ensures even spacing of the various legs of the star pattern 370 and that none of the U-shaped turns 382 in the pattern 370 have a radius smaller than the industry standard.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A roof clip for use in securing a heating cable to a flat roof surface comprising:
a mounting plate including a plurality of infusion holes; and
a plurality of cable clamps each including:
a first guide;
a second guide; and
a bendable member joining the first guide and the second guide that is bendable over a heating cable such that, when bent, the heating cable is trapped between the first guide and the second guide.

2. The roof clip of claim 1 wherein the first guide is curved.

3. The roof clip of claim 1 wherein the second guide is curved.

4. The roof clip of claim 2 wherein the first guide has a radius.

5. The roof clip of claim 4 wherein the second guide has a radius equal to the radius of the first guide.

6. A system for preventing a buildup of ice on a roof, the system comprising:
a plurality of roof clip assemblies fastenable to a flat surface on a roof;
a heating cable routable through the plurality of roof clip assemblies; and
a routing pattern having a plurality of legs in which each leg is formed by:
the heating cable passing through a first cable clamp of one or more of the plurality of roof clips in a sequential order;
the heating cable turns back on itself to form a U-shape; and
the heating cable passes through a second cable clamp of the one or more of the plurality of roof clips in an order that is reverse of the sequential order, thereby forming a leg of the plurality of legs.

7. The system of claim 6 wherein at least one of the plurality of roof clip assemblies comprises:
a mounting plate connectable to flat surface; and
two cable clamps extending from edges of the mounting plate.

8. The system of claim 7 wherein the mounting plate comprises a plurality of infusion holes through which adhesive infuses when the adhesive compressed between the mounting plate and the flat roof surface.

9. The system of claim 7 wherein at least one of the two cable clamps comprises:
a first guide;
a second guide; and
a bendable member joining the first and second guides that is bendable over a heating cable such that, when bent, the heating cable is trapped between the first guide and the second guide.

10. The system of claim 7 wherein both of the two cable clamps comprises:
a first guide;
a second guide; and
a bendable member joining the first and second guides that is bendable over a heating cable such that, when bent, the heating cable is trapped between the first guide and the second guide.

11. The system of claim 9 wherein the first guide is curved.

12. The system of claim 11 wherein the second guide is curved.

13. The system of claim 12 wherein the first guide has a radius.

14. The system of claim 13 wherein the second guide has a radius equal to the radius of the first guide.

15. A method of preventing a buildup of ice on a flat roof with a downspout comprising:
fastening a plurality of roof clips to a flat roof surface, each clip having two cable clamps; and
routing a heating cable through the plurality of roof clips to form a pattern including a plurality of legs that radiate from a downspout of the roof.

16. The method of claim 15 wherein fastening the plurality of roof clips comprises adhesively fastening the plurality of roof clips to the flat roof surface.

17. The method of claim 16 wherein adhesively fastening the plurality of roof clips to the flat roof surface comprises placing adhesive on the flat surface and compressing a mounting plate into the adhesive until adhesive infuses through infusion holes formed in the mounting plate.

18. The method of claim 15 wherein routing a heating cable through the plurality of roof clips to form a pattern including a plurality of legs that radiate from a downspout of the roof comprises bending a bendable member such that the heating cable is trapped between a first guide and a second guide connected by the bendable member.

19. The method of claim 18 wherein bending a bendable member such that the heating cable is trapped between the first guide and the second guide comprises bending the bendable member by hand.

20. The method of claim 18 wherein bending a bendable member such that the heating cable is trapped between the first guide and the second guide comprises bending the bendable member using a pliers.
